(19) United States
(12) Patent Application Publication
(10) Pub. No.: US 2017/0188286 A1
(43) Pub. Date: Jun. 29, 2017

(54) RADIO COMMUNICATION SYSTEM AND BASE STATION

(71) Applicant: FUJITSU LIMITED, Kawasaki-shi (JP)

(72) Inventors: Takeshi YONEKURA, Kawasaki (JP); Noboru HASEGAWA, Oota (JP); Takahiro KAWAGUCHI, Kamakura (JP); Kazunari KOBAYASHI, Yokohama (JP)

(21) Appl. No.: 15/357,283

(22) Filed: Nov. 21, 2016

(30) Foreign Application Priority Data
Dec. 25, 2015 (JP) 2015-255198

(51) Int. Cl. H04W 36/32; H04W 36/30; H04W 36/08; H04W 16/28; H04W 36/00

(52) U.S. Cl. CPC H04W 36/32; H04W 16/28; H04W 36/0016; H04W 36/08; H04W 36/30

(57) ABSTRACT

A radio communication system includes: a first base station including a memory, and a processor coupled to the memory and configured to form a first radio area, and execute first beamforming to direct a beam to a radio terminal moving from the first radio area toward a second radio area; and a second base station including a memory, and a processor coupled to the memory and configured to form the second radio area that does not overlap the first radio area, receive information on the identification of the position of the radio terminal from the first base station, and execute second beamforming to direct a beam to the radio terminal based on the received information on the identification of the position of the radio terminal.

### CROSS-REFERENCE TO RELATED APPLICATION

This application is based upon and claims the benefit of priority of the prior Japanese Patent Application No. 2015-255198, filed on Dec. 25, 2015, the entire contents of which are incorporated herein by reference.

### FIELD

The embodiment discussed herein is related to a radio communication system and a base station.

### BACKGROUND

In a radio communication system such as a cellular system, multiple base stations are installed and set so that boundaries between cells that are an example of radio areas overlap and that a dead zone is avoided as much as possible.

As examples of the related art, International Publication Pamphlet No. WO2009/57544, Japanese Laid-open Patent Publication No. 2011-087009, U.S. Patent Application Publication No. 2010/0291931, and U.S. Patent Application Publication No. 2011/0085448 are known.

### SUMMARY

According to an aspect of the invention, a radio communication system includes: a first base station including a first memory, and a first processor coupled to the memory and configured to form a first radio area, and execute first beamforming to direct a beam to a radio terminal moving from the first radio area toward a second radio area; and a second base station including a second memory, and a second processor coupled to the memory and configured to form the second radio area that does not overlap the first radio area, receive information on the identification of the position of the radio terminal from the first base station, and execute second beamforming to direct a beam to the radio terminal based on the received information on the identification of the position of the radio terminal.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a radio communication system according to a related-art example;

FIG. 2 is a diagram illustrating a radio communication system according to an embodiment;

FIG. 3 is a diagram illustrating the radio communication system according to the embodiment;

FIG. 4 is a diagram illustrating the radio communication system according to the embodiment;

FIG. 5 is a functional block diagram of each of base stations according to the embodiment;

FIG. 6 is a diagram illustrating an example of a communication sequence between a base station according to the embodiment and a radio terminal;

FIG. 7A is a diagram illustrating an example of weights for beamforming;

FIG. 7B is a diagram illustrating an example of the beamforming;

FIG. 8 is a diagram illustrating an example of a communication sequence between base stations according to the embodiment and the radio terminal;

FIG. 9 is a diagram illustrating an example of information stored in the base stations according to the embodiment;

FIG. 10 is a diagram illustrating an example of information stored in the base stations according to the embodiment;

FIG. 11 is a diagram describing an example of a process of calculating, based on a direction from a first base station according to the embodiment to the radio terminal, a direction from a second base station according to the embodiment to the radio terminal;

FIG. 12 is a diagram describing an example of a process of calculating, based on a direction from the first base station according to the embodiment to the radio terminal, a direction from the second base station according to the embodiment to the radio terminal;

FIG. 13 is a diagram is a diagram describing an example of processes to be executed by the two base stations according to the embodiment;

FIG. 14A is a block diagram illustrating an example of a hardware configuration of each of the base stations according to the embodiment;

FIG. 14B is a block diagram illustrating an example of a hardware configuration of the radio terminal according to the embodiment;

FIG. 15 is a diagram describing an example of a process of calculating, based on a direction from the first base station according to the embodiment to the radio terminal, a direction from the second base station according to the embodiment to the radio terminal;

FIG. 16 is a diagram describing a modified example of the calculation processes described with reference to FIGS. 11, 12, and 15; and

FIG. 17 is a diagram illustrating the radio communication system according to the embodiment.

### DESCRIPTION OF EMBODIMENT

In the aforementioned system, however, the boundaries between the cells overlap each other, interference (that may be hereinafter abbreviated as “inter-cell interference”) of radio waves between the cells may occur at edges of the cells, and the throughput may be reduced.

As examples of a technique for suppressing the occurrence of inter-cell interference, there are Coordinated Multi-Point transmission/reception (CoMP), enhanced Inter-Cell Interference Coordination (eICIC), and the like.

However, CoMP and eICIC are techniques for suppressing interference while consuming radio resources, and efficiencies in the use of radio resources in a radio communication system may be reduced.

If base stations are installed so that boundaries between cells do not overlap each other, the occurrence of inter-cell interference is suppressed without the use of an inter-cell interference suppression technique such as CoMP or eICIC, and radio resources may be effectively used. However, a region in which cells do not overlap each other is a dead zone, and a radio terminal may not be able to communicate with a base station in the region.

As one aspect of the present embodiment, provided are solutions for being able to suppress interference between radio areas of multiple base stations and ensure the continuity of communication.

Hereinafter, the embodiment is described with reference to the accompanying drawings.

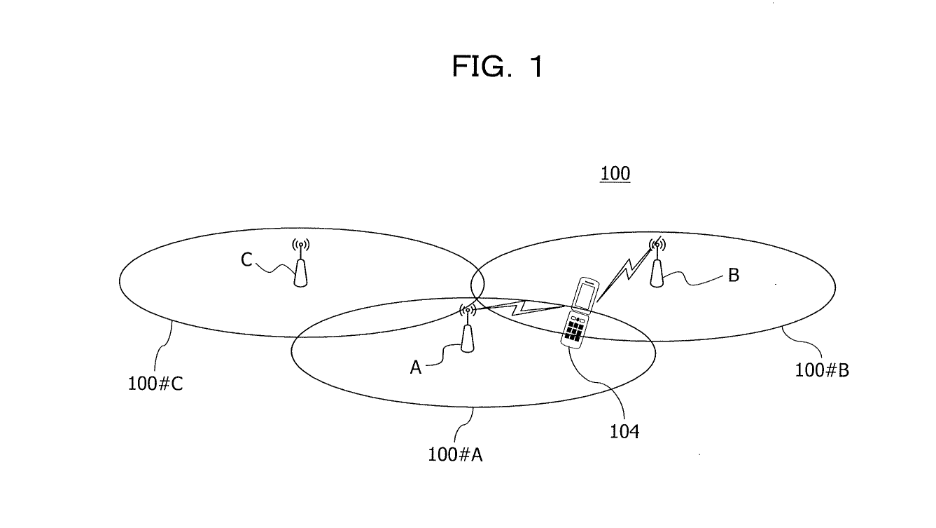

FIG. 1 is a diagram illustrating an example of the configuration of a radio communication system according to a comparative example with respect to the embodiment described later. A radio communication system 100 illustrated in FIG. 1 includes three base stations A, B, and C, for example. The base stations A, B, and C form cells 100#A, 100#B, and 100#C as an example of radio areas, respectively.

The cells 100#A, 100#B, and 100#C are formed so that the cells 100#A, 100#B, and 100#C partially overlap each other. For example, a radio terminal 104 located in a region in which the cells 100#A and 100#B overlap each other receives radio waves from the base stations A and B, and inter-cell interference may occur.

In a case where the aforementioned CoMP or eICIC is used, the base stations A and B assign radio resources to the same radio terminal 104 so as to avoid the occurrence of interference between the radio waves and may suppress inter-cell interference.

For example, if CoMP is used, a communication frequency assigned by the base station A to the radio terminal 104 is different from a communication frequency assigned by the base station B to the radio terminal 104. If eICIC is used, a communication time assigned by the base station A to the radio terminal 104 is different from a communication time assigned by the base station B to the radio terminal 104. For example, during the time when one of the base stations A and B transmits a signal to the radio terminal 104, the other of the base stations A and B does not transmit a signal to the radio terminal 104. In other words, if eICIC is used, the base stations A and B suppress inter-cell interference in a time region by controlling the positions and rates of subframes in which a data signal is not transmitted.

If CoMP or eICIC is used, radio resources assigned to the radio terminal 104 located in the region in which the cells overlap each other are different and inter-cell interference may be suppressed, but the efficiency in the use of the radio resources may be reduced, as described above.

If the base stations A and B are installed so that the cells 100#A and 100#B do not overlap each other, inter-cell interference is suppressed without the use of CoMP and eICIC, but a dead zone exists between the cells 100#A and 100#B. If the radio terminal 104 is located in the dead zone, the radio terminal 104 is not able to communicate with the base stations A and B.

For example, if the radio terminal 104 moves from one of the cells 100#A and 100#B to the other of the cells 100#A and 100#B, communication is disconnected in the dead zone. In other words, the radio terminal 104 is not appropriately handed over between the base stations A and B, and the continuity of the communication is not ensured.

The embodiment describes an example in which the effective use of radio resources and the continuity of communication are ensured.

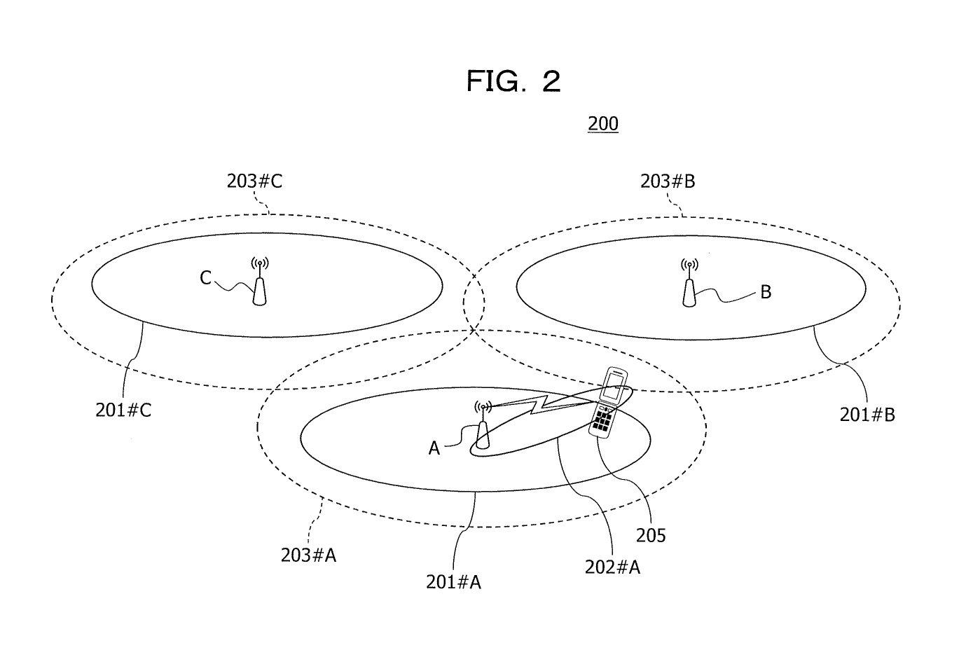

FIG. 2 is a diagram illustrating a radio communication system 200 according to the embodiment. Referring to FIG. 2, the radio communication system 200 includes a base station A, a base station B, and a base station C. In an example illustrated in FIG. 2, the number of base stations is 3, but may be 2 or 4 or more.

The base stations A to C may be connected to a core network via S1 interfaces, for example. The S1 interfaces are an example of connection interfaces between the base stations and a node (that may be referred to as a “core node”) that is an element of the core network.

In addition, the base stations A to C may be connected to each other via X2 interfaces, for example. The X2 interfaces are an example of connection interfaces between the base stations.

The base stations A, B, and C may form radio areas 201#A, 201#B, and 201#C, respectively, for example. The radio areas formed by the “base stations” may be referred to as “coverage” in which radio waves transmitted by the “base stations” reach a target terminal or the radio areas formed by the “base stations” may be referred to as “radio service areas” or “radio service ranges”. The “radio areas” may be referred to as “cells”. If multiple cells are formed by the same “base station”, the cells may be referred to as “sectors”.

When a radio terminal 205 is located in any of the radio areas 201#A, 201#B, and 201#C, the radio terminal 205 is able to communicate with a base station forming the radio area. For example, when the radio terminal 205 is located in the cell 201#A, the radio terminal 205 is able to communicate with the base station A.

The “cells” may be formed by antennas included in bodies of the base stations or may be formed by radio devices connected to the bodies of the base stations via cables or wirelessly connected to the bodies of the base stations and installed at positions (remote sites) separated from the bodies of the base stations.

An example of the radio devices is remote radio equipment (RRE). The RRE corresponds to blocks that have modulation and demodulation functions and radio functions separated from the bodies of the base stations and are installed in the remote sites separated from the bodies of the base stations, as described above.

The RRE may be connected to the bodies of the base stations via optical fiber transmission paths and communicate with the bodies of the base stations via the optical fiber transmission paths. The RRE may be portions of the bodies of the base stations or may be base stations other than the bodies of the base stations.

The radio terminal 205 is an example of radio equipment and may be a mobile terminal. The radio terminal 205 that is the mobile terminal may be referred to as a mobile terminal 205 or a mobile station 205.

The mobile station 205 may be hold and moved by a user or may be attached to a mobile unit such as a vehicle and moved. An example of the mobile station 205 is user equipment (UE).

In the example illustrated in FIG. 2, the single radio terminal 205 exists in the radio communication system 200, but two or more radio terminals 205 may exist in the radio communication system 200.

The base stations A to C may change spatial shapes (that may be referred to as “directionality”) of the radio areas 201#A to 201#C by beamforming, for example. For example, each of the base stations A to C may direct a beam to the specific radio terminal 205 and direct a beam to a place at which the specific radio terminal 205 is not located in order to avoid interference with the specific radio terminal 205. In addition, the base stations A to C may change the directionality to receive a radio signal from the specific radio terminal 205.

In other words, the base stations A to C may enlarge and reduce the radio areas 201#A to 201#C by the beamforming in specific directions. The “radio areas” formed without the execution of the beamforming may be referred to as “central areas” for convenience sake, and areas to which the radio areas are able to be enlarged from the “central areas” by the beamforming may be referred to as “peripheral areas” or “enlarged areas”.

In the embodiment, the radio areas 201#A to 201#C may be set so that the “central areas” do not overlap each other in parts or all of the multiple radio areas 201#A to 201#C and that the “peripheral areas” overlap each other in parts or all of the multiple radio areas 201#A to 201#C. In other words, the “central areas” may be separated from each other, and the “peripheral areas” may not be separated from each other.

For example, in FIG. 2, the central areas 201#A and 201#B do not overlap each other, but the peripheral areas 203#A and 203#B partially overlap each other. In addition, the central areas 201#B and 201#C do not overlap each other, but the peripheral areas 203#B and 203#C partially overlap each other.

As illustrated in FIG. 2, the base station A may direct a beam 202#A to the radio terminal 205 by the beamforming. The base station A may execute the beamforming to enlarge a range in which the radio terminal 205 is able to wirelessly communicate with the base station A, from the central area 201#A to the peripheral area 203#A in a direction from the base station A to the radio terminal 205.

Similarly, the base station B may execute the beamforming to enlarge a range in which the radio terminal 205 is able to wirelessly communicate with the base station B, from the central area 201#B to the peripheral area 203#B in a direction from the base station B to the radio terminal 205.

Similarly, the base station C may execute the beamforming to enlarge a range in which the radio terminal 205 is able to wirelessly communicate with the base station C, from the central area 201#C to the peripheral area 203#C in a direction from the base station B to the radio terminal 205.

In order for each of the base stations to execute the beamforming, the base station has multiple antennas and executes precoding to change the phases of multiple radio signals by multiplying baseband signals for the multiple radio signals to be supplied to the multiple antennas by different coefficients. Each of the base stations may execute the precoding to change the power of baseband signals for multiple radio signals to be supplied to multiple antennas.

In order for each of the base stations to execute the precoding, multiple precoding matrices that indicate coefficients by which baseband signals are multiplied may be set in advance. In addition, the multiple precoding matrices may be associated with codes, and the radio terminal 205 may notify a base station with which the radio terminal 205 communicates of a code indicating the result of the selection of a precoding matrix that is optimal for the reception state of the radio terminal 205. In the example illustrated in FIG. 2, the base station A may detect, based on the result of the selection of the precoding matrix by the radio terminal 205, a direction from an antenna of the base station A to the radio terminal 205. A data structure in which multiple precoding matrices are associated with codes is referred to as a codebook in some cases.

In addition, the radio terminal 205 measures the quality (quality of radio communication) of a signal transmitted by the base station A and received by the radio terminal 205 and reports the measured quality to the base station A. The base station A may estimate the distance between the radio terminal 205 and the base station A based on the reported quality of the reception. In this case, the base station A may estimate that as the quality of the reception is lower, the radio terminal 205 is located farther from the antenna of the base station A. For example, if the quality of the reception includes the strength of the received signal transmitted by the base station A, the base station A may estimate the distance between the antenna of the base station A and the radio terminal 205 by using the fact that the strength of the received signal is inversely proportional to the square of the distance between the antenna of the base station A and the radio terminal 205.

Thus, since the base station A may estimate the distance to the radio terminal 205 and a direction in which the radio terminal 205 is located, the base station A may estimate the position of the radio terminal 205.

The radio terminal 205 may detect the position of the radio terminal 205 without using a precoding matrix and the strength of a received signal and report the detected position to the base station A, and the base station A may detect the position of the radio terminal 205. The radio terminal 205 may use a global positioning system (GPS) to detect the position of the radio terminal 205. The radio terminal 205 may estimate the position of the radio terminal 205 with higher accuracy by using the GPS. Alternatively, the radio terminal 205 may detect the position of the radio terminal 205 using identification information emitted by a radio frequency (RF) tag for near field communication or the like. In other words, the radio terminal 205 may associate the identification information emitted by the RF tag or the like with information on the position of the arranged RF tag and detect the position of the radio terminal 205 based on the positional information associated with the identification information emitted by the RF tag or the like. The RF tag may be used in a building or the like or in a range in which a GPS signal does not reach the RF tag.

If the base station A and the radio terminal 205 use the same frequency resource to communicate with each other in a time division manner, the base station A may determine a precoding matrix based on the symmetry of a communication path. In this case, the radio terminal 205 may not determine a precoding matrix, and the configuration and operations of the radio terminal 205 are simplified. Although a case where a precoding matrix is determined by the radio terminal 205 is described below, the embodiment is applicable to a case where the base station A determines a precoding matrix.

When the radio terminal 205 does not communicate with the base station A and communicates with any of the base stations B and C, the base stations B and C may detect the position of the radio terminal 205 in the same manner as described above. The following description assumes that the radio terminal 205 is located in the radio area formed by the base station A. The embodiment, however, is applicable to a case where the radio terminal 205 is located in a radio area formed by any of the base stations B and C.

When the radio terminal 205 moves from the central area 201#A toward the peripheral area 203#A, the quality of the radio communication with the base station A is reduced. For example, when the radio terminal 205 is located near a boundary (cell edge) of the central area 201#A, the quality of the radio communication is equal to or lower than a threshold (referred to as “first threshold”). If the base station A detects that the quality of the radio communication is equal to or lower than the first threshold, the base station A executes the beamforming to direct the beam 202#A to the radio terminal 205. Thus, if the radio terminal 205 moves out of the central area 201#A but is located in the peripheral area 203#A, the radio terminal 205 may continue to communicate with the base station A.

When the beamforming is executed and the radio terminal 205 moves from a place located near a boundary of the peripheral area 203#A toward the cell 201#B or the cell 201#C, the quality of the radio communication is reduced. Thus, if the base station A executes the beamforming, and the quality of the radio communication with the radio terminal 205 becomes equal to or lower than a threshold (referred to as “second threshold”), the base station A hands over the radio terminal 205 to the base station B or the base station C. The first threshold may be equal to the second threshold or may be different from the second threshold.

The outline of a process for the handover is described below. Since the base station A may estimate the position of the radio terminal 205 as described above, the base station A may acquire information on the identification of the position of the radio terminal 205. Thus, the base station A searches an adjacent base station positional information database (described later) using the information on the identification of the position of the radio terminal 205. It is assumed that the base station A detects that the radio terminal 205 is closer to the base station B than the base station C as a result of the search. In this case, the base station A transmits, to the base station B via an X2 interface, the information on the identification of the position of the radio terminal 205.

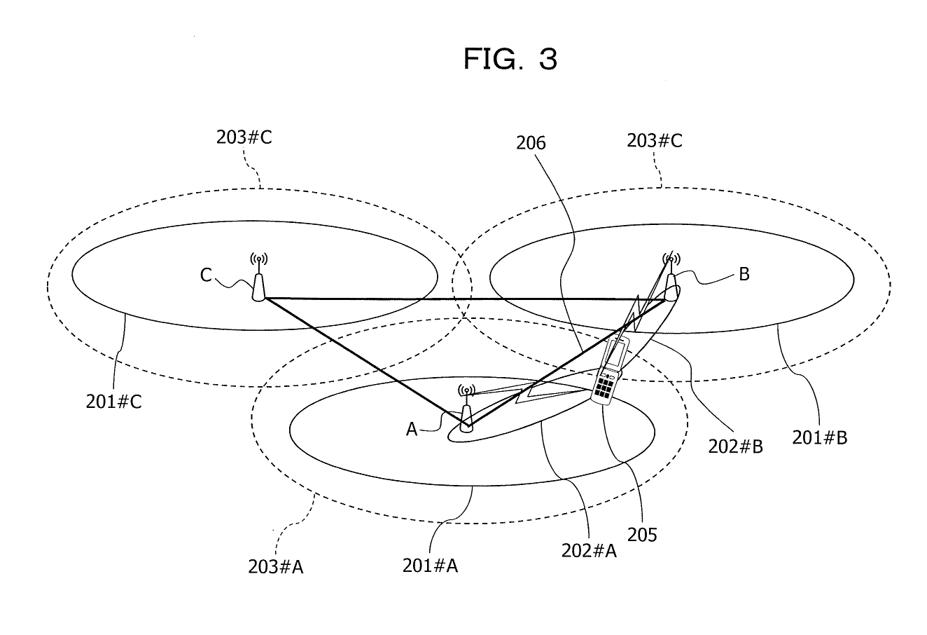

The base station B receives the information on the identification of the position of the radio terminal 205 from the base station A and may direct a beam 202#B to the radio terminal 205 by the beamforming, as illustrated in FIG. 3.

The base stations A and B may execute the beamforming to cause the beam 202#A formed by the base station A and the beam 202#B formed by the base station B to overlap each other at the position of the radio terminal 205. Thus, the radio terminal 205 is able to be handed over from the base station A to the base station B while continuing the communication. This handover may be referred to as “inter-beam handover”.

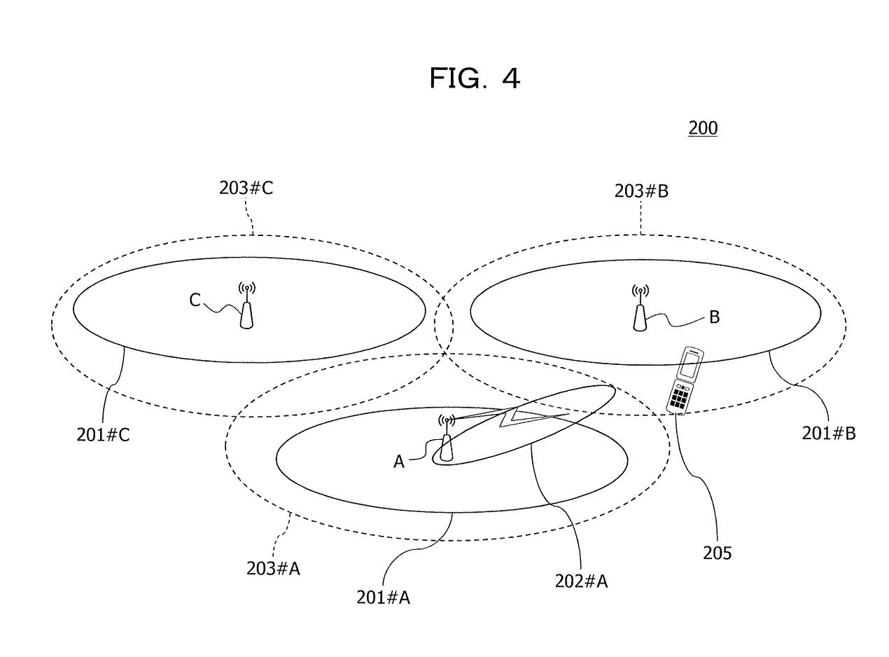

In other words, as illustrated in FIG. 4, this beamforming may avoid a movement of the radio terminal 205 to a place outside the peripheral area 203#A and avoid the disconnection of the communication with the base station A. In addition, the beamforming may avoid the disconnection of the communication that may be caused by the fact that the radio terminal 205 is not located in the central area 201#B and not able to be handed over to the base station B. Thus, the continuity of a communication service may be ensured.

As the information on the identification of the position of the radio terminal 205, information identified by the base station A may be used. In this case, as the information on the identification of the position of the radio terminal 205, the distance and direction from the base station A to the radio terminal 205 may be used. The base station B may calculate a direction from the base station B to the radio terminal 205 using information indicating the position of the installed base station A and the distance and direction from the base station A to the radio terminal 205.

In addition, as the information on the identification of the position of the radio terminal 205, information on the position detected by the radio terminal 205 using the GPS or the RF tag may be used. The positional information detected by the radio terminal 205 may be transmitted by the radio terminal 205 to the base station A and transmitted to the base station B via an X2 interface and received by the base station B. The base station B may receive the positional information detected by the radio terminal 205 and calculate a direction from the base station B to the radio terminal 205.

Alternatively, as the information on the identification of the position of the radio terminal 205, information that indicates a direction in which the base station A directs the beam 202#A by the beamforming may be used. For example, as the information on the identification of the position of the radio terminal 205, a precoding matrix or information indicating the precoding matrix may be used. In this case, the base station B may use the distance between the base stations A and B, a direction from the base station A to the base station B, and transmission power of the base station A to calculate a region in which the quality of the radio communication when the base station A communicates with the radio terminal 205 is reduced to a level equal to or lower than the second threshold. Then, the base station B may calculate the position of an intersection of the region in which the quality of the radio communication when the base station A communicates with the radio terminal 205 is reduced to the level equal to or lower than the second threshold and the direction in which the base station A directs the beam 202#A by the beamforming, or the base station B may calculate a place located near the intersection. Thus, the base station B may calculate the direction from the base station B to the radio terminal 205.

As described above, in the embodiment, the central area 201 #A and the central area 201#B are separated from each other, and inter-cell interference between the base stations A and B may be suppressed. Thus, radio resources to be used by the base stations A and B are not limited, and the base stations A and B may freely use radio resources without a waste of radio resources. In addition, since adjacent central areas may be separated from each other, distances between the base stations may be set to be large and the number of base stations to be installed may be reduced. Furthermore, since the sizes of the central areas may be small without a reduction in the number of base stations, transmission power may be low and saved.

When the handover is executed as illustrated in FIG. 3, the beam 202#A and the beam 202#B partially overlap each other. For the handover, the radio terminal 205 receives a reference signal transmitted by the base station B. The base station B transmits the reference signal using a radio resource different from that used by the adjacent base station A. Thus, even when the beam 202#A and the beam 202#B partially overlap each other as illustrated in FIG. 3, the occurrence of interference between the beams during the handover may be suppressed.

The state in which the radio terminal 205 approaches the cell 201#B from the inside of the cell 201#A and communicates with the base station A, and the handover to the base station B, are described above. In the same manner, the radio terminal 205 may approach the cell 201#C from the inside of the cell 201#A and be handed over to the base station C from a state in which the radio terminal 205 communicates with the base station A. In this case, the cell 201#A and the cell 201#C are separated from each other, and the peripheral area 203#A and the peripheral area 203#C overlap each other.

The base stations A, B, and C have different base station devices, respectively, and the information on the identification of the position of the radio terminal 205 is transmitted from the base station A to the base station B, as described above, for example. The embodiment, however, is not limited to the case where the base stations A, B, and C have the different base station devices, respectively. For example, the RRE may be installed at positions indicated by the symbols A, B, and C in FIGS. 2 to 4, and a base station device that controls the RRE may be installed at any of the positions indicated by the symbols A, B, and C or may be installed at another position. In addition, if multiple RREs are controlled by a single base station device, the information on the identification of the position of the radio terminal 205 is input, output, and transferred within the base station device and input, output, and transferred between the base station device and the RREs.

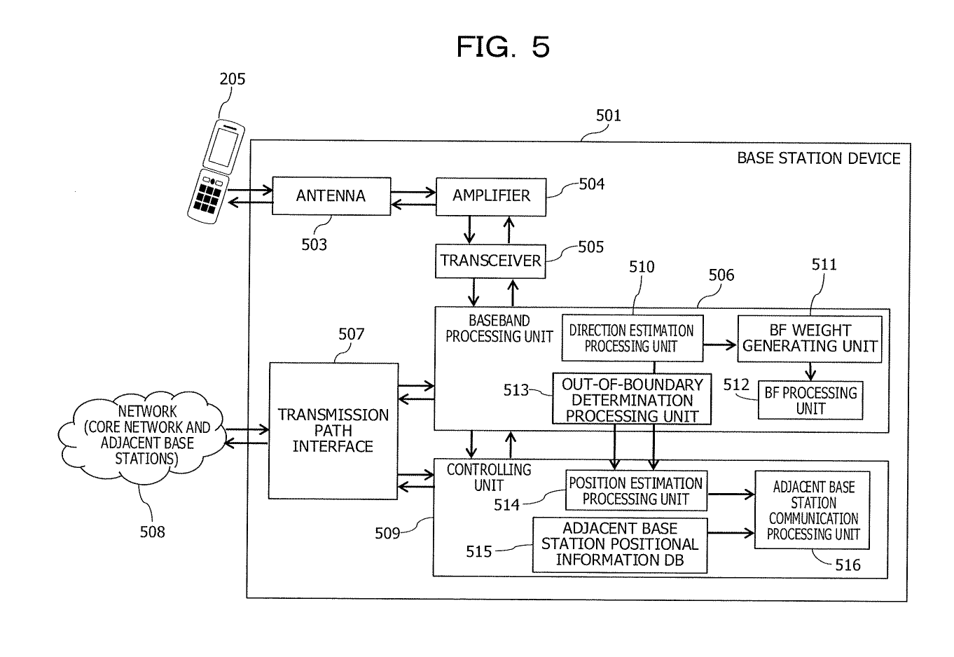

FIG. 5 is a functional block diagram of each of the base stations A, B, and C as each of the base station devices. A base station device 501 includes an antenna 503, an amplifier 504, a transceiver 505, a baseband processing unit 506, a transmission path interface 507, and a controller 509.

The antenna 503 transmits a radio signal to the radio terminal 205 and receives a radio signal from the radio terminal 205. The antenna 503 may be composed of groups of multiple antennas and direct a beam to the radio terminal 205 by the beamforming. Alternatively, the antenna 503 may have a structure with directionality and physically change its orientation to direct the beam to the radio terminal 205, like a parabolic antenna or a Yagi antenna.

The amplifier 504 amplifies a signal corresponding to a radio signal to be transmitted from the antenna 503 and amplifies a signal corresponding to a radio signal received by the antenna 503. When a signal received from the transceiver 505 and to be transmitted is amplified by the amplifier 504, the radio signal is transferred to the antenna 503 and emitted from the antenna 503 into air. When a signal received from the antenna 503 is amplified by the amplifier 504, the signal is transferred to the transceiver 505.

The transceiver 505 executes frequency conversion between a baseband signal processed by the baseband processing unit 506 and a signal to be transmitted and between a received signal and a baseband signal to be processed by the baseband processing unit 506. Specifically, the transceiver 505 converts a signal received from the amplifier 504 into a baseband signal and transfers the baseband signal to the baseband processing unit 506. In addition, the transceiver 505 converts a baseband signal received from the baseband processing unit 506 into a signal to be transmitted and transfers the signal to the amplifier 504.

The baseband processing unit 506 processes a baseband signal. Specifically, the baseband processing unit 506 converts, into a baseband signal, a signal received from a network 508 via the transmission path interface 507 and to be transmitted to the radio terminal 205. The network 508 includes a core network. In addition, the network 508 includes communication lines 206 on which the X2 interfaces are installed between the base stations illustrated in FIG. 3, for example. Furthermore, the baseband processing unit 506 converts a converted baseband signal received from the radio terminal 205 into a signal to be transmitted to the network 508 and transfers the signal to the transmission path interface 507.

In addition, the baseband processing unit 506 includes a direction estimation processing unit 510, a beamforming (BF) weight generating unit 511, a BF processing unit 512, and an out-of-boundary determination processing unit 513.

The direction estimation processing unit 510 functions as a direction estimator configured to estimate a direction in which the radio terminal 205 is located. As described above, the direction estimation processing unit 510 may estimate, based on a code of a precoding matrix selected by the radio terminal 205, the direction in which the radio terminal 205 is located. In other words, the direction estimation processing unit 510 may estimate that the radio terminal 205 is located in a direction in which the base station device 501 directs the beam based on the precoding. In addition, the base station device 501 may receive, from the radio terminal 205, the positional information detected by the radio terminal 205 using a signal from a GPS satellite or the like, and the direction estimation processing unit 510 may estimate, based on the position of the installed base station device 501, the direction in the radio terminal 205 is located.

The BF weight generating unit 511 generates weight signals corresponding to coefficients by which baseband signals are multiplied. For example, the BF weight generating unit 511 references the codebook, specifies a precoding matrix, extracts elements of the precoding matrix, and generates the weight signals indicated by the extracted elements.

The BF processing unit 512 multiplies the weight signals generated by the BF weight generating unit 511 and corresponding to the coefficients by the baseband signals.

The out-of-boundary determination processing unit 513 estimates the distance between the base station device 501 and the radio terminal 205. For example, the out-of-boundary determination processing unit 513 estimates the distance between the base station device 501 and the radio terminal 205 based on the quality, reported by the radio terminal 205, of radio communication between the radio terminal 205 and the base station device 501. In this case, the out-of-boundary determination processing unit 513 functions as a detector configured to detect the degree of a reduction in the quality of the radio communication with the radio terminal 205. The result of the estimation of the distance may not be indicated as a specific length and may be indicated as information indicating the quality of the radio communication or as any of levels into which the quality of the radio communication is classified. In addition, the base station device 501 may receive, from the radio terminal 205, the positional information detected by the radio terminal 205 using the GPS or the like, and the out-of-boundary determination processing unit 513 may estimate the distance based on the received positional information and information on the position of the base station device 501. In this case, the out-of-boundary determination processing unit 513 may calculate a specific length as the distance. In this manner, the out-of-boundary determination processing unit 513 may estimate, based on the estimation of the distance, whether the radio terminal 205 is located in a central area or a peripheral area.

In addition, the out-of-boundary determination processing unit 513 may hold history records of the distance between the base station device 501 and the radio terminal 205. Thus, the out-of-boundary determination processing unit 513 may calculate the direction of a movement of the radio terminal 205 and the speed at which the radio terminal 205 moves. For example, when the radio terminal 205 is located in the peripheral area, the out-of-boundary determination processing unit 513 may appropriately determine, based on the direction of the movement, a base station to which the base station device 501 transmits the information on the identification of the position of the radio terminal 205. In addition, when the radio terminal 205 moves from the central area toward the peripheral area, the out-of-boundary determination processing unit 513 may estimate, based on the movement speed, a time period from the current time to the time when the beamforming or the like is started, for example.

The controller 509 executes a protocol process for communication with the radio terminal 205 and the network 508, a call control process, a process of handing over the radio terminal 205, a process of monitoring failures of the units of the base station device 501, and the like.

In addition, the controller 509 includes a position estimation processing unit 514, an adjacent base station positional information database (DB) 515, and an adjacent base station communication processing unit 516.

The position estimation processing unit 514 estimates the position of the radio terminal 205 based on the distance estimated by the out-of-boundary determination processing unit 513 and the direction, estimated by the direction estimation processing unit 510, in which the radio terminal 205 is located. For example, the position estimation processing unit 514 estimates a longitude and latitude at which the radio terminal 205 is located. In addition, the position estimation processing unit 514 may estimate, based on longitudes and latitudes, a range in which the radio terminal 205 is located.

The adjacent base station positional information database 515 is a database for storing the positions of base stations adjacent to the base station device 501. The positions of the adjacent base stations may be expressed using longitudes and latitudes, for example. Alternatively, the positions of the adjacent base stations may be expressed using polar coordinates based on distances between the base station device 501 and the adjacent base stations and orientations (for example, angles with respect to a reference direction) of the adjacent base stations relative to the position of the base station device 501.

The adjacent base station positional information database 515 may not be included in the controller 509. For example, the adjacent base station positional information database 515 may be included in a server device with which the base station device 501 is able to communicate. In this case, the controller 509 communicates with the server device, searches the adjacent base station positional information database 515, and the like.

When the radio terminal 205 is located at an edge of the central area, the adjacent base station communication processing unit 516 functions as a transmitter and receiver for transmitting and receiving the information on the identification of the position of the radio terminal 205 to and from a base station located adjacent to a base station forming the cell in which the radio terminal 205 is located. Specifically, the adjacent base station communication processing unit 516 references the adjacent base station positional information database 515 and the position, estimated by the position estimation processing unit 514, of the radio terminal 205. Then, the adjacent base station communication processing unit 516 determines the adjacent base station or a destination of the information of the identification of the position of the radio terminal 205 and transmits the information of the identification of the position of the radio terminal 205 to the determined adjacent base station via the transmission path interface 507.

In addition, when receiving the information on the identification of the position of the radio terminal 205 from an adjacent base station, the adjacent base station communication processing unit 516 calculates a direction in which the radio terminal 205 is located and the BF weight generating unit 511 executes a process of directing a beam in the calculated direction. Thus, the adjacent base station communication processing unit 516 selects a precoding matrix to be used to direct the beam in the calculated direction and transmits the selected precoding matrix to the BF weight generating unit 511.

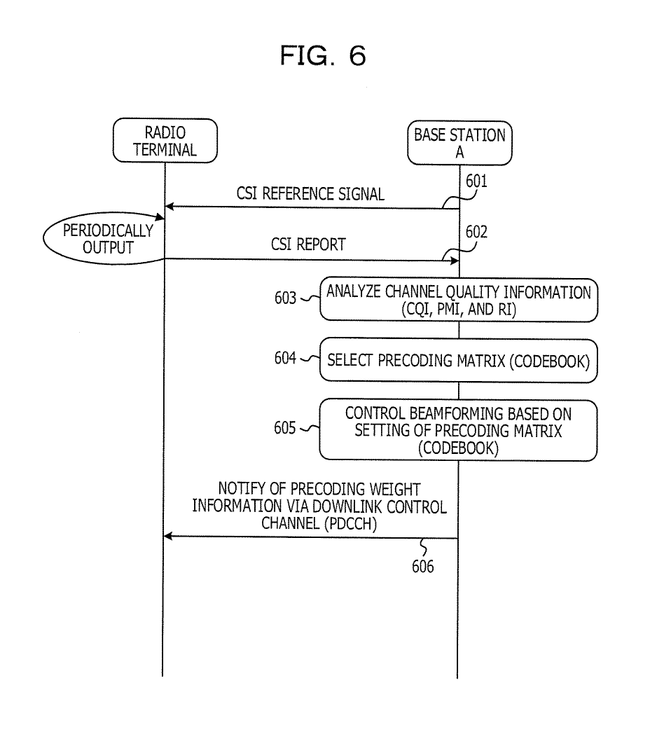

FIG. 6 is a diagram illustrating an example of a communication sequence between the radio terminal 205 and the base station device 501. In step S601, the base station device 501 transmits a channel state information (CSI) reference signal to the radio terminal 205. The CSI reference signal is a signal to be used for the radio terminal 205 to measure the quality of a radio signal received from the base station device 501. The radio terminal 205 measures the quality of the reception for the transmission of the CSI reference signal by the base station device 501. In step S602, the radio terminal 205 transmits a CSI report to the base station device 501 via an uplink control channel. If the base station device 501 periodically transmits the CSI reference signal, the radio terminal 205 may periodically transmit the CSI report to the base station device 501. In addition, the base station device 501 may cause the CSI reference signal to include a parameter for time periods at which the CSI report is transmitted, and the base station device 501 may cause the radio terminal 205 to periodically transmit the CSI report.

The CSI report includes, as information indicating the quality of the reception, information related to channel quality information on a communication path between the radio terminal 205 and the base station device 501. The channel quality information may include CQI, RI, and PMI. The CQI is an abbreviation for channel quality information, the RI is an abbreviation for a rank indicator, and the PMI is an abbreviation for a precoding matrix indicator. The CQI indicates the quality of a signal received via a downlink channel per defined unit of frequency. The RI indicates the optimal number of layers for the radio terminal 205 among numbers of layers controlled based on the state of the channel. The PMI is an index (code) for a precoding matrix that causes the total throughput of the layers to be the highest after the precoding.

In step S603, the base station device 501 processes the received CSI report and analyzes the channel quality information.

In step S604, the base station device 501 selects a precoding matrix from the codebook or the like based on the channel quality information analyzed in step S603.

In step S605, the base station device 501 transfers the precoding matrix selected in step S604 to the BF weight generating unit 511 and executes the precoding. In this case, the base station device 501 executes the precoding to multiply multiple baseband signals by signals corresponding to coefficients and change the phases of the signals and levels of transmission power and thereby executes the beamforming.

In step S606, the base station device 501 may notify the radio terminal 205 of precoding weight information via a downlink control channel (physical downlink control channel (PDCCH)). The reason why the precoding weight information is notified is that the radio terminal 205 may reference the precoding weight information indicating the current precoding matrix in order to calculate the PMI for the generation of a next CSI report.

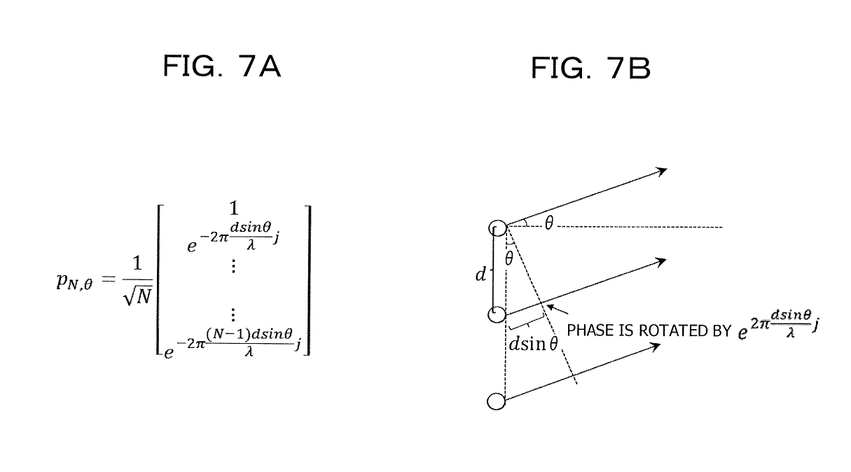

FIG. 7A illustrates an example of coefficients pN, θ by which multiple baseband signals are multiplied in the precoding. The coefficients pN, θ are an example of coefficients for a case where a number N of antennas are arranged at intervals of d as illustrated in FIG. 7B, the wavelengths of radio signals emitted by the antennas are λ, and the antennas direct beams in a direction forming an angle of θ with a normal to a main surface of the antennas while rotating the phases of the beams. In this case, the difference between distances by which radio signals emitted by adjacent antennas are transmitted is d×sin θ, and the difference between the phases of the radio signals emitted by the adjacent antennas is exp(j(2πd sin θ/λ)), where j is an imaginary unit. Thus, the coefficients by which the baseband signals are multiplied are multiples of exp(j(2πd sin θ/λ)).

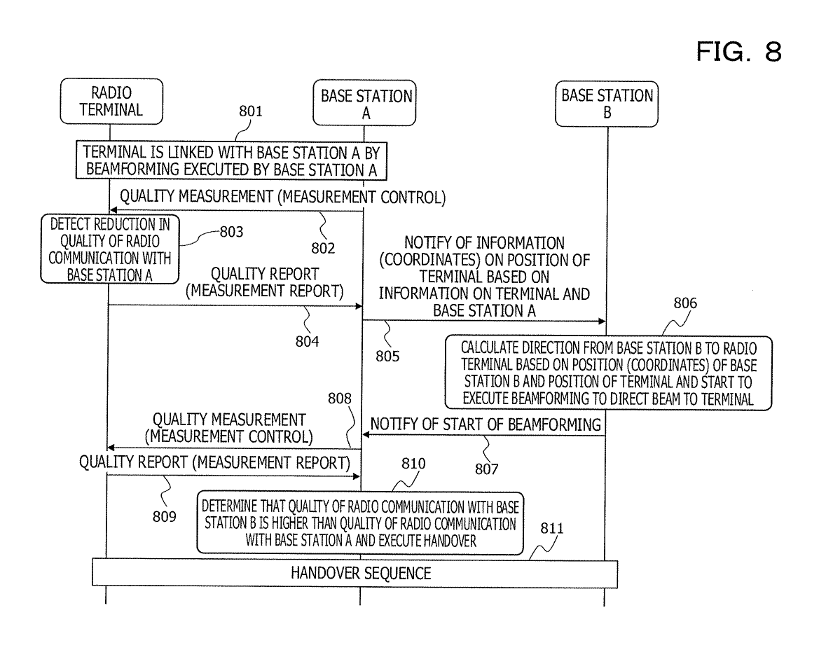

FIG. 8 is a diagram illustrating an communication sequence from the state in which the radio terminal 205 communicates with the base station A as illustrated in FIG. 2 to a state immediately before the radio terminal 205 is handed over to the base station B as illustrated in FIG. 3.

In step S801, the base station A communicates with the radio terminal 205 (or is linked with the radio terminal 205). In this case, in order to avoid interference of communication with another radio terminal, the BF processing unit 512 may direct a beam to the radio terminal 205 based on the CSI report.

In step S802, the base station A transmits a quality measurement message (measurement control) to the radio terminal 205. The radio terminal 205 receives the quality measurement message, measures the quality of the radio communication with the base station A, and transmits a quality report (measurement report) to the base station A. The quality measurement message may include information indicating the quality of the radio communication. In this case, if the radio terminal 205 that received the quality measurement message detects that the quality of the radio communication with the base station A is reduced to a level equal to or lower than the quality, indicated in the quality measurement message, of the radio communication, the radio terminal 205 may transmit the quality report. For example, if the radio terminal 205 that received the quality measurement message detects the quality of the radio communication that corresponds to the time when the radio terminal 205 approaches the boundary of the central area 201#A or approaches an intermediate location between the central area 201#A and the central area 201#B, the radio terminal 205 may transmit the quality report.

It is assumed that, after step S804, the quality of the radio communication between the radio terminal 205 and the base station A is reduced. For example, if the radio terminal 205 detects that the quality of the radio communication becomes equal to or lower than the predetermined threshold (or the aforementioned first threshold) in the process of step S803 or that a predetermined requirement is established, the radio terminal 205 transmits the quality report message to the base station A as the process of step S804.

It is assumed that the base station A references the adjacent base station positional information database 515 and detects the base station B as an adjacent base station forming a cell toward which the radio terminal 205 moves. In this case, in a process of step S805, the base station A transmits, to the base station B, the information on the identification of the position of the radio terminal 205 that is information on the position of the radio terminal 205 or the like.

The base station B that received the information on the identification of the position of the radio terminal 205 may calculate a direction from the base station B to the radio terminal 205 in a process of step S806. After the calculation of the direction to the radio terminal 205, the base station B causes the BF weight generating unit 511 to generate the weight signals for the predetermined coefficients and causes the BF processing unit 512 to direct a beam in the calculated direction.

If the information on the identification of the position of the radio terminal 205 indicates that the position of the radio terminal 205 is expressed by a longitude and a latitude, the base station B may use a longitude and latitude of the base station B to calculate the orientation of the radio terminal 205 relative to the base station B.

As a process of step S807, the base station B may notify the base station A that the base station B started to execute the beamforming to direct the beam to the radio terminal 205. Thus, the base station A may detect that the base station B directed the beam to the radio terminal 205, and the base station A may hand over the radio terminal 205 to the base station B after the detection and avoid the disconnection of the communication of the radio terminal 205.

As a process of step S808, the base station A retransmits the quality measurement message to the radio terminal 205. Thus, if the radio terminal 205 further approaches the base station B, and the quality of the radio communication between the radio terminal 205 and the base station A is reduced to a level equal to or lower than the aforementioned second threshold, the radio terminal 205 may transmit the quality report to the base station A as a process of step S809.

When receiving the quality report, the base station A may determine that the quality of the radio communication between the radio terminal 205 and the base station B is higher than the quality of the radio communication between the radio terminal 205 and the base station A in step S810. Then, the base station A causes the controller 509 to start a process of handing over the radio terminal 205 to the base station B. Then, in step S811, a handover sequence is executed and the radio terminal 205 is handed over to the base station B.

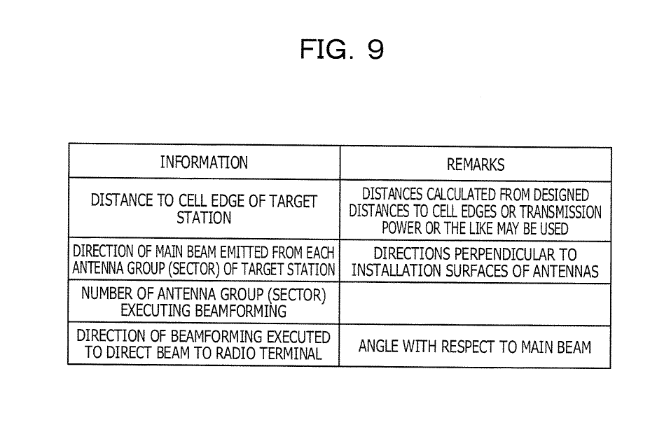

FIG. 9 is a diagram illustrating a specific example of information to be referenced by the position estimation processing unit 514 to estimate the position of the radio terminal 205. This information is stored in a memory included, as hardware (described later), in the base station device or is stored in a device (not illustrated) accessible via the network. For example, if the enlarged cell 203#A and the cell 201#A are formed in circles, the distances between the base station A and the edges of the cells are equal to the radii of the enlarged cell 203#A and cell 201#A, for example. The distances between the base station A and the edges of the cells may be calculated using designed distances between the base station A and the edges of the cells or may be calculated from transmission power of the antenna 503. Directions in which main beams are emitted from antenna groups of the base station A are directions (normal directions) perpendicular to installation surfaces of the antenna groups. In addition, if each of the enlarged cell 203#A and the cell 201#A is divided into multiple sectors by the multiple antenna groups oriented in multiple directions, the normal directions of the antenna groups are defined for the sectors, respectively. If the multiple antenna groups are provided, numbers of the antenna groups (sectors) that execute the beamforming are information that identifies the antenna groups. A direction in which a beam is emitted to the radio terminal by the beamforming is defined by an angle with respect to the main beam or an angle with respect to a normal direction of an antenna group. If the multiple antenna groups are provided, directions in which beams are emitted from the antenna groups by the beamforming are defined.

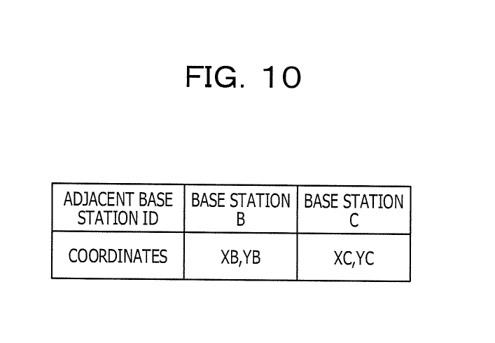

FIG. 10 is a diagram illustrating an example of information stored in the adjacent base station positional information database 515. For example, in the adjacent base station positional information database 515 of the base station A, information on the positions of the base stations B and C located adjacent to the base station A is associated with identification information of the base stations B and C and stored. When the out-of-boundary determination processing unit 513 detects that the radio terminal 205 moves away from the peripheral area 203#A, the ID of a base station located closest to the position, estimated by the position estimation processing unit 514, of the radio terminal 205 is searched from the adjacent base station positional information database 515.

If an antenna of any of the base stations B and C is separated from a base station device for controlling the antenna, information that indicates the position of the antenna may be stored in the adjacent base station positional information database 515. Thus, relationships between adjacent radio areas formed by radio signals emitted from antennas may be reflected in the search.

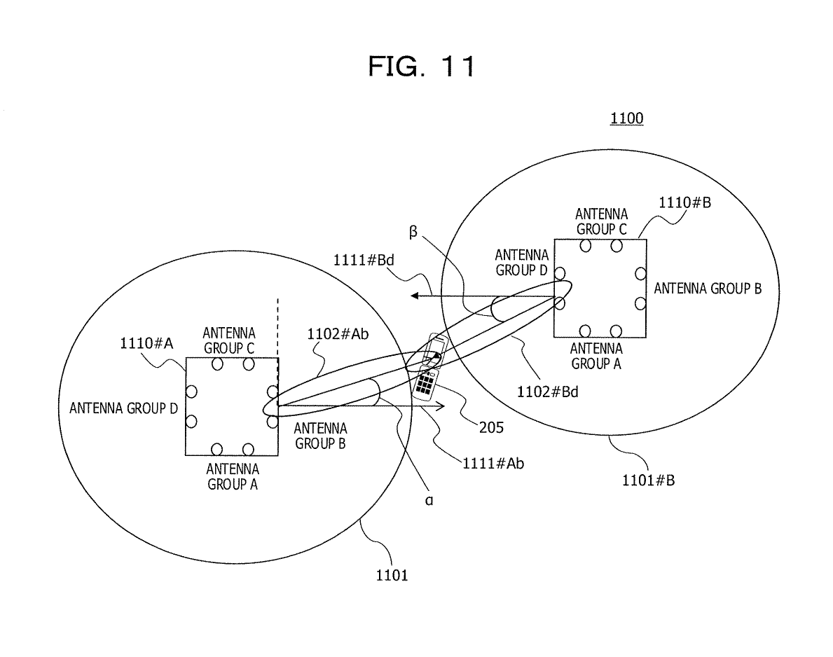

FIG. 11 is a diagram illustrating an example of a process of calculating a direction from the adjacent base station B to the radio terminal 205 based on a direction from the base station A of the radio communication system 1100 according to the embodiment to the radio terminal 205. It is assumed that, in the radio communication system 1100, the base station A transmits the information on the identification of the position of the radio terminal 205 to the base station B. FIG. 11 is the diagram describing the calculation of a direction from an antenna group D of the base station B to the radio terminal 205 based on a direction from an antenna group B of the base station A to the radio terminal 205 in the assumed case.

It is assumed that the base station A has an antenna group A, the antenna group B, and antenna groups C and D as an antenna 1110#A and forms a radio area (cell) 1101#A. In FIG. 11, an illustration of peripheral areas is omitted. In this case, an angle formed between a normal direction 1111#Ab of the antenna group B of the base station A and a direction in which a beam 1102#Ab is emitted from the antenna group B of the base station A toward the radio terminal 205 is α. The symbol α may indicate a direction associated with a precoding matrix. The distance between the antenna group B and the radio terminal 205 is expressed by r. The position of the radio terminal 205 is expressed by (rsosα, r sin α) as a coordinate position while the origin of a coordinate system is the center of the antenna group B.

It is assumed that the base station B has antenna groups A, B, and C and the antenna group D as an antenna 1110#B and forms a cell 1101#B. In addition, the base station B uses the antenna group D to direct a beam 1102#Bd to the radio terminal 205 based on the information transmitted by the base station A and related to the identification of the position of the radio terminal 205. An angle formed between a normal direction 1111#Bd of the antenna group D and a direction from the base station B to the radio terminal 205 is β. The position of the radio terminal 205 may be expressed (rsosβ, r sin β) as a coordinate position while the origin of a coordinate system is the center of the antenna group D of the antenna 1110#A of the base station B. In order to simplify the description, the distance between the antenna group D and the radio terminal 205 is r.

If the position of the antenna 1110#A of the base station A, the position of an antenna of the radio terminal 205, and the position of the antenna 1110#B of the base station B are expressed by (XA, YA), (xm, ym), and (XB, YB) as coordinate positions with respect to the surface of the earth, the following is established: (xm, ym)=(XA+r cos α, YA+r sin α). In addition, if the normal direction of the antenna group B of the base station A and the normal direction of the antenna group D of the base station B form an angle of 180 degrees, the following is established: (xm, ym)=(XB−r cos β, YB−r sin β). Since cos β=(XB−XA−r cos α)/r sin β=(YB−YA−r sin α)/rr, XA, XB, YA, YB, and a are known, β is able to be calculated.

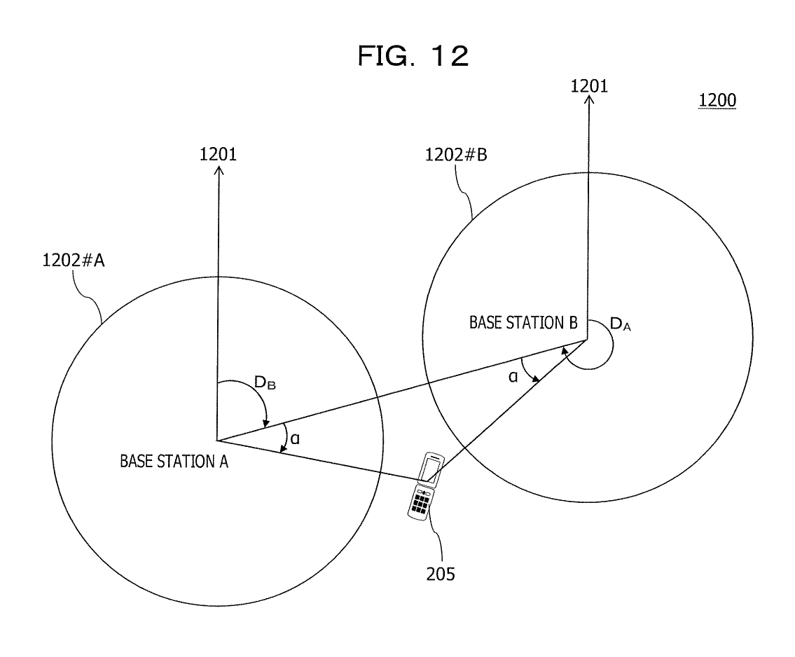

FIG. 12 is a diagram describing an example of a process of calculating a direction from the base station B to the radio terminal 205 based on a direction from the base station A to the radio terminal 205 using polar coordinates in an easier manner in a case where the radio terminal 205 is located so that the distance between the radio terminal 205 and the base station A is equal to the distance between the radio terminal 205 and the base station B. If transmission power of the base station A is equal to transmission power of the base station B, and the radio terminal 205 is located so that the distance between the radio terminal 205 and the base station A is equal to or nearly equal to the distance between the radio terminal 205 and the base station B, the radio terminal 205 may be handed over from the base station A to the base station B. If the radio terminal 205 is located so that the distance between the radio terminal 205 and the base station A is equal to or nearly equal to the distance between the radio terminal 205 and the base station B, the information on the identification of the position of the radio terminal 205 may be transmitted by the base station A to the base station B, and the process of calculating the direction may be executed.

Standard directions from the base stations A and B are indicated by a reference number 1201. In FIG. 12, D_{B} indicates a direction angle between the standard direction 1201 from the base station A and a direction from the base station A to the base station B, and D_{B}+α indicates a direction angle between the standard direction 1201 from the base station A and a direction from the base station A to the radio terminal 205.

In addition, a direction angle between the standard direction 1201 from the base station B and a direction from the base station B to the base station A is indicated by D_{A}.

Since an isosceles triangle is formed by the positions of the radio terminal 205, base station A, and base station B, the orientation of the radio terminal 205 relative to the base station B may be calculated as D_{A}−α. The orientation of the base station A relative to the base station B is stored in the base station B. Thus, the direction from the base station A to the radio terminal 205 in a case where the direction from the base station A to the base station B is used as a standard direction is transmitted from the base station A to the base station B, and the direction from the base station B to the radio terminal 205 may be easily calculated.

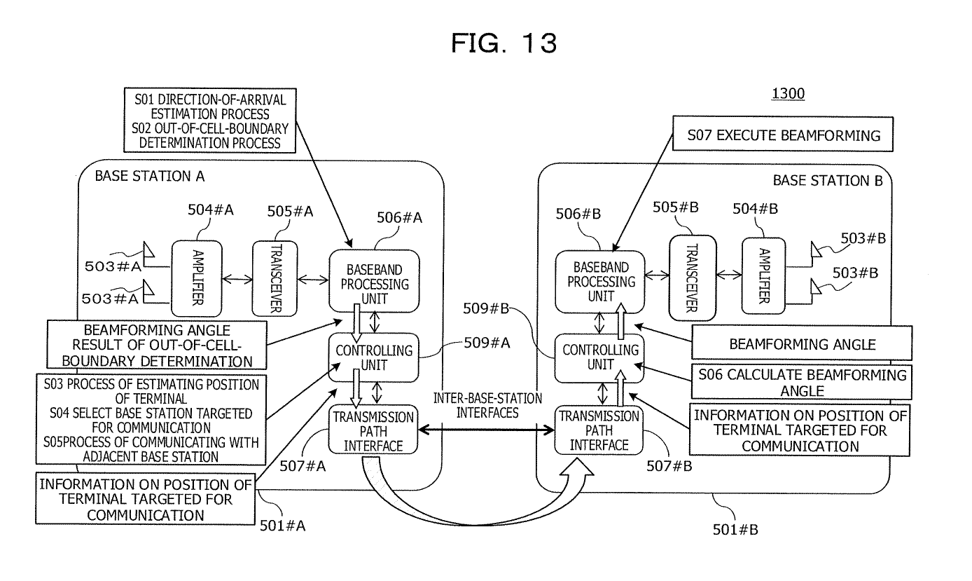

FIG. 13 is a diagram describing an example of processes to be executed by the two base stations A (501#A) and B (501#B) according to the embodiment. It is assumed that the radio terminal 205 communicates with the base station A (501#A). In this case, as a process of step S01, the direction estimation processing unit 510 of the baseband processing unit 506#A executes a process (direction-of-arrival estimation process) of estimating a direction (direction of arrival) from the base station A (501#A) to the radio terminal. In the estimation of the direction, a precoding matrix to be used by the BF weight generating unit 511 or the like is used. In addition, as a process of step S02, the out-of-boundary determination processing unit 513 executes a process (out-of-cell-boundary determination process) of estimating the distance from the base station A (501#A) to the radio terminal 205.

As a result of steps S01 and S02, the out-of-boundary determination processing unit 513 transmits a beamforming angle (or the direction from the base station A to the radio terminal 205) and the result (or the distance from the base station A to the radio terminal 205) of the out-of-cell-boundary determination process to the controller 509#A.

As a process of step S03, the position estimation processing unit 514 of the controller 509#A estimates the position of the radio terminal 205 based on the beamforming angle and the result of the out-of-cell-boundary determination process. In addition, as a process of step S04, the controller 509#A selects, based on the estimation of the position of the radio terminal, the base station B (501#B) as a base station to which the radio terminal 205 is to be handed over. The adjacent base station communication processing unit 516 of the controller 509#A executes a process of communicating with the adjacent base station as a process of step S05. Thus, the base station A transmits information on the position of the radio terminal targeted for communication or the information on the identification of the position of the radio terminal to the transmission path interface 507#B of the base station B (501#B) via the transmission path interface 507#A.

The adjacent base station communication processing unit 516 of the controller 509#B calculates the beamforming angle based on the information received by the transmission path interface 507#B and related to the identification of the position of the radio terminal 205 as a process of step S06. The calculated beamforming angle is transmitted to the baseband processing unit 506#B, and the BF weight generating unit 511#B executes the beamforming as a process of step S07.

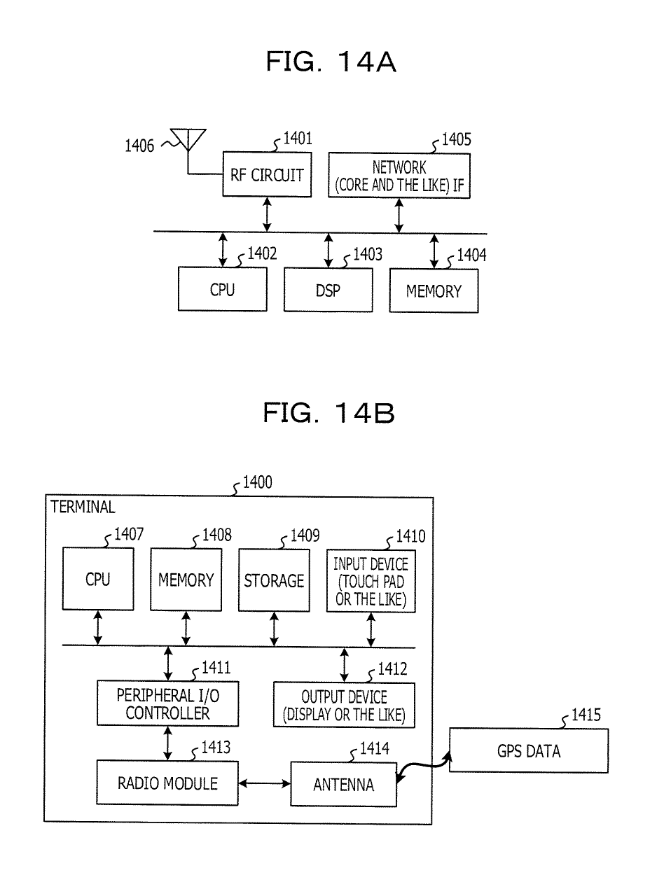

FIG. 14A is a block diagram illustrating an example of a hardware configuration of each of the base station devices. Each of the base stations has, as hardware, an RF circuit 1401, a central processing unit (CPU) 1402, a digital signal processor (DSP) 1403, a memory 1404, and a network interface (IF) 1405 that are connected to each other by a bus.

The RF circuit 1401 is connected to an antenna 1406. The antenna 1406 corresponds to the antenna 503 illustrated in FIG. 5. The RF circuit 1401 corresponds to the amplifier 504 and the transceiver 505.

The DSP 1403 outputs and receives signals to and from the RF circuit 1401 and corresponds to the baseband processing unit 506. The DSP 1403 may be configured to execute a program stored in a storage device such as the memory 1404 or may be composed of a field programmable gate array (FPGA) as hardware. The network interface (IF) 1405 corresponds to the transmission path interface 507.

The CPU 1402 executes the program stored in the memory 1404 and outputs and receives data to and from the DSP 1403 and the network interface 1405. The CPU 1402 corresponds to the controller 509 illustrated in FIG. 5. The controller 509 may be achieved by executing the program by the CPU 1402. The program to be executed by the CPU 1402 may be achieved by hardware. For example, a process corresponding to the program to be executed by the CPU 1402 may be achieved by an FPGA.

FIG. 14B is a block diagram illustrating an example of a hardware configuration of the radio terminal. A radio terminal 1400 has, as hardware, a CPU 1407, a memory 1408, storage 1409, an input device 1410, a peripheral I/O controlling unit 1411, an output device 1412, a radio module 1413, and an antenna 1414.

The CPU 1407 executes a program stored in the storage 1409 and loaded in the memory 1408, controls the input device 1410 and the output device 1412, and provides a user interface to a user of the radio terminal 1400. In addition, the CPU 1407 outputs and receives, via the peripheral I/O controlling unit 1411, signals to and from the radio module 1413 connected to the antenna 1414. The radio module 1413 communicates with a base station via the antenna 1414. In addition, the radio module 1413 may acquire radio data 1415 of the GPS via the antenna 1414.

The scope of the disclosure is not limited to the aforementioned embodiment. For example, the aforementioned embodiment may be extended as follows.

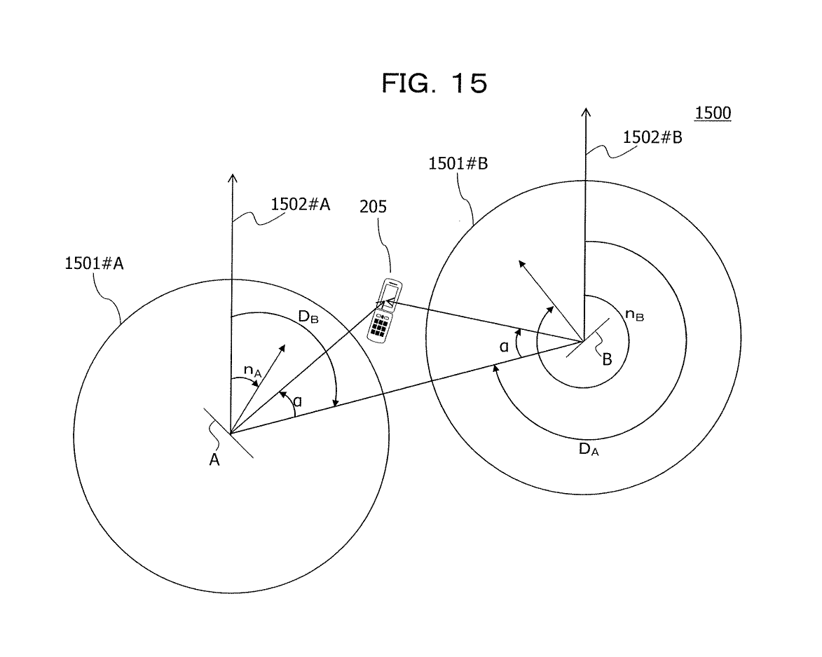

Although the normal direction of the antenna group B of the base station A and the normal direction of the antenna group D of the base station A form the angle of 180 degrees in the example illustrated in FIG. 11, the normal direction of the antenna group B of the base station A and the normal direction of the antenna group D of the base station B may form an arbitrary angle. As illustrated in FIG. 15, a northward direction from the base station A and a northward direction from the base station B are indicated by 1502#A and 1502#B, like FIG. 12. The orientation of a normal to a main surface of the antenna group A of the base station A relative to the direction 1502#A is indicated by n_{A}, while the orientation of a normal to a main surface of the antenna group B of the base station B relative to the direction 1502#B is indicated by n_{B}.

In this case, since the orientation of the radio terminal relative to the orientation n_{A} may be calculated based on a precoding matrix or the like, the orientation of the radio terminal relative to the direction from the antenna group A to the antenna group B may be calculated based on the orientation n_{A} and the orientation D_{B} of the antenna group B relative to the direction 1502#A. If an isosceles triangle is formed by the positions of the radio terminal 205, base station A, and base station B, the orientation of the radio terminal relative to the direction from the antenna group B to the antenna group A is indicated by −α. Thus, n_{B}−α−D_{A} is the orientation of the radio terminal relative to the orientation of the normal to the main surface of the antenna B.

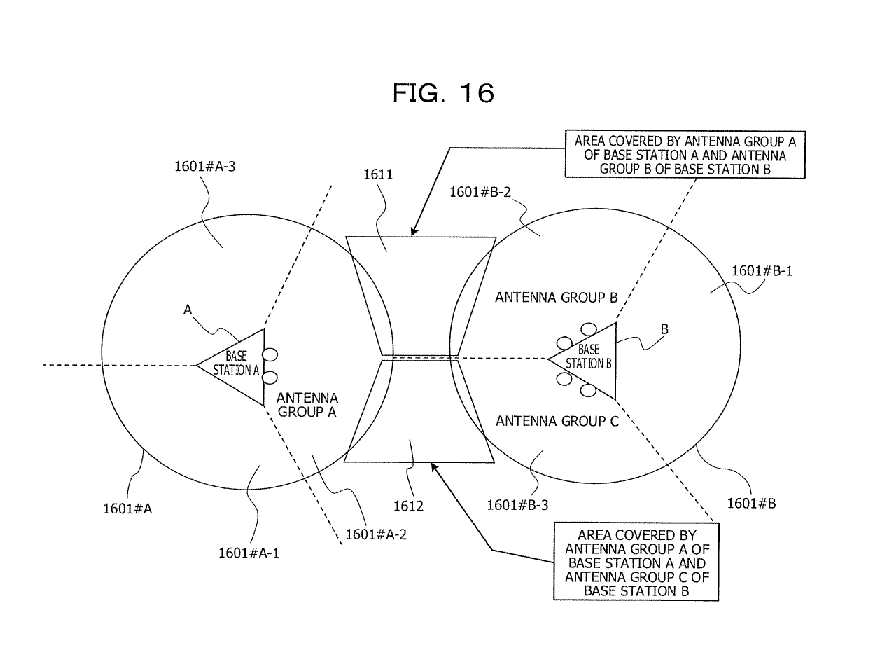

In addition, the number of antenna groups included in each of the base stations is not limited to 4. For example, as illustrated in FIG. 16, it is assumed that the base station A include three antenna groups and that a central area 1601#A formed by the base station A is divided into three sectors 1601#A-1, 1601#A-2, and 1601#A-3. In addition, it is assumed that the base station B includes three antenna groups and that a central area 1601#B formed by the base station B is divided into three sectors 1601#B-1, 1601#B-2, and 1601#B-3.

It is assumed that the sector 1601#A-2 is formed by the antenna group A of the base station A and that the sectors 1601#A-1 and 1601#A-3 are formed by the other two antenna groups of the base station A. In addition, it is assumed that the sector 1601#B-2 is formed by the antenna group B of the base station B and that the sector 1601#B-3 is formed by the antenna group C of the base station B. Furthermore, it is assumed that the sector 1601#B-1 is formed by the other antenna group of the base station B.

A normal direction of the antenna group A of the base station A forms an angle other than an angle of 180 degrees with each of normal directions of the antenna groups B and C of the base station B. For example, as illustrated in FIG. 16, it is assumed that the normal direction of the antenna group A of the base station A forms angles of approximately 60 degrees with the normal directions of the antenna groups B and C of the base station B.

In this case, a region 1611 is an area covered by the antenna group A and the antenna group B. In other words, when the radio terminal moves from the sector 1601#A-2 toward the sector 1602#B-2 or the sector 1602#B-3 and is located in the region 1611, the beamforming is executed by the antenna group B. When the radio terminal is located in a region 1612 that is an area covered by the antenna group A and the antenna group C, the beamforming is executed by the antenna group C.

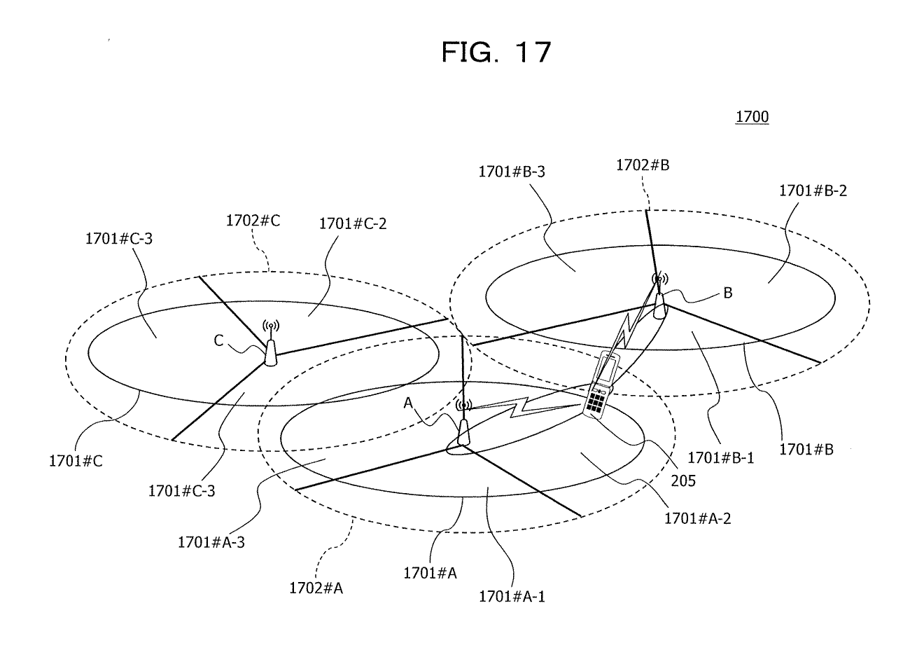

FIG. 17 is a diagram describing a case where each of central areas 1701#A, 1701#B, and 1701#C formed by the base stations A, B, and C is divided into multiple sectors, a part of sectors of each of the base stations A, B, and C overlaps a sector formed by at least any of the other base stations and the embodiment is applicable to each of the sectors. In FIG. 17, the central area 1701#A is divided into sectors 1701#A-1, 1701#A-2, and 1701#A-3, the central area 1701#B is divided into sectors 1701#B-1, 1701#B-2, and 1701#B-3, and the central area 1701#C is divided into sectors 1701#C-1, 1701#C-2, and 1701#C-3.

In this case, the sectors 1701#A-3 and 1701#C-3 overlap each other. When the radio terminal 205 is located in a region in which the sectors 1701#A-3 and 1701#C-3 overlap each other or the radio terminal 205 is located near the region, the base stations A and C use CoMP or the like to communicate with the radio terminal 205.

In FIG. 17, the sectors 1701#A-2 and 1701#B-1 are separated from each other. Thus, when the radio terminal 205 moves from the inside of the sector 1701#A-2 to a place located outside the sector 1701#A-2, the base station A may direct a beam to the radio terminal 205. In addition, when the radio terminal 205 moves out of the sector 1701#A-2 and approaches the sector 1701#B-2, the base station A transmits the information on the identification of the position of the radio terminal 205 to the base station B, and the base station B may direct a beam to the radio terminal 205. Thus, the base station A may hand over the radio terminal 205 to the base station B.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A radio communication system comprising:
a first base station including
a first memory, and
a first processor coupled to the memory and configured to
form a first radio area, and
execute first beamforming to direct a beam to a radio terminal moving from the first radio area toward a second radio area; and
a second base station including
a second memory, and
a second processor coupled to the memory and configured to
form the second radio area that does not overlap the first radio area,
receive information on the identification of the position of the radio terminal from the first base station, and
execute second beamforming to direct a beam to the radio terminal based on the received information on the identification of the position of the radio terminal.

2. The radio communication system according to claim 1,
wherein the first processor is configured to
execute a detecting process that detects reduction of radio communication quality between the first base station and the radio terminal,
execute a first controlling process that executes the first beamforming to direct the beam to the radio terminal in response to the detection by the detecting process, and
execute a transmitting process that transmits the information on the identification of the position of the radio terminal to the second base station in response to the detection by the detecting process, and
wherein the second processor is configured to
execute a receiving process that receives the information on the identification of the position of the radio terminal, and
execute a second controlling process that executes the second beamforming based on the information received by the receiving process and related to the identification of the position of the radio terminal.

3. The radio communication system according to claim 1,
wherein the information on the identification of the position of the radio terminal includes information indicating the direction of the beamforming executed by the first base station.

4. The radio communication system according to claim 3,
wherein the direction of the beamforming is determined based on a precoding index received by the first base station from the radio terminal.

5. The radio communication system according to claim 1,
wherein the information on the identification of the position of the radio terminal includes information on the position, identified by the first base station, of the radio terminal.

6. The radio communication system according to claim 1,
wherein the information on the identification of the position of the radio terminal includes positional information detected by the radio terminal and received by the first base station.

7. The radio communication system according to claim 1,
wherein the first processor is configured to
execute a handover process that hands over the radio terminal to the second base station if radio reception quality that is reported by the radio terminal after the transmission of the information on the identification of the position of the radio terminal to the second base station is higher than radio quality reported by the radio terminal during the execution of the first beamforming.

8. A base station for forming a first radio area and executing first beamforming to direct a beam to a radio terminal moving from the first radio area toward a second radio area, the base station comprising:
a memory; and
a processor coupled to the memory and configured to
execute a detecting process that detects reduction of radio communication quality between the base station and the radio terminal, and
execute a transmitting process that transmits, to another base station forming the second radio area that does not overlap the first radio area, information related to the identification of the position of the radio terminal and to be used for the other base station to execute second beamforming to direct a beam to the radio terminal.

9. The base station according to claim 8,
wherein the information on the identification of the position of the radio terminal includes information indicating the direction of the beamforming executed to direct the beam to the radio terminal.

10. The base station according to claim 9,
wherein the direction of the first beamforming is determined based on a precoding index received from the radio terminal.

11. The base station according to claim 8,
wherein the information on the identification of the position of the radio terminal includes information on the position of the radio terminal.

12. The base station according to claim 11,
wherein the information on the identification of the position of the radio terminal includes positional information identified based on positional information detected by the radio terminal.

13. The base station according to claim 8,
wherein the processor of the base station is configured to
execute a handover process that hands over the radio terminal to the other base station if radio reception quality that is reported by the radio terminal after the transmission of the information on the identification of the position of the radio terminal to the other base station is higher than radio quality reported by the radio terminal during the execution of the first beamforming.

14. A base station for forming a second radio area that does not overlap a first radio area formed by another base station, comprising:
a memory; and
a processor coupled to the memory and configured to
execute a receiving process that receives information on the identification of the position of a radio terminal from the other base station that executes first beamforming to direct a beam to the radio terminal moving the first radio area toward the second radio area, and
execute a controlling process that executes second beamforming to direct a beam to the radio terminal based on the information received by the receiving process and related to the identification of the position of the radio terminal.

15. The base station according to claim 14,
wherein the information on the identification of the position of the radio terminal includes information indicating the direction of the first beamforming executed to direct the beam to the radio terminal.

16. The base station according to claim 14,
wherein the information on the identification of the position of the radio terminal includes information on the position, identified by the other base station, of the radio terminal.

17. The base station according to claim 16,
wherein the information on the identification of the position of the radio terminal includes information on the position, identified by the other base station based on positional information detected by the radio terminal, of the radio terminal.

18. The base station according to claim 17,
wherein the information on the identification of the position of the radio terminal includes positional information detected by the radio terminal and identified by the other base station.

19. The base station according to claim 14,
wherein the processor of the base station is configured to
execute a second handover process that executes a process of handing over the radio terminal from the other base station to the base station after the execution of the second beamforming.
